(19) United States
(12) Patent Application Publication
(10) Pub. No.: US 2019/0047645 A1
(43) Pub. Date: Feb. 14, 2019

(54) Bicycle Hand Brake Restraint With Armored Brake Lines

(71) Applicant: Ricky Burt Seratt, Portland, OR (US)

(72) Inventor: Ricky Burt Seratt, Portland, OR (US)

(21) Appl. No.: 15/987,176

(22) Filed: May 23, 2018

(51) Int. Cl. B62H 5/18; B62H 5/00; E05B 71/00

(52) U.S. Cl. CPC B62H 5/18; E05B 71/00; B62H 5/003; B62H 5/001

(57) ABSTRACT

The subject of this disclosure is a fully armored anti-cut protective brake line system with an anti-theft hand brake restraint for all bicycles with hand brakes. The hand brake restraint cannot operate effectively without the armored brake lines as well as having armored brake lines are of no reason without the hand brake restraint. This invention is a bicycle anti-theft deterrent.

### BACKGROUND OF THE INVENTION

I ride the city bus and put my bike on the front rack of the bus while going from place to place. Because of fear of my bike getting stolen off the rack I found myself standing up front of the bus while riding to keep a close eye on it. I began brain storming as I looked at my bike on how I could protect it better so I could sit down and look away and enjoy my bus ride better. It is then that I thought of this invention and in my search found what is below.

There are two other patents like I have which are the “Bike Brake” and “Grip Lock”. Though both of them are focused on the handle portion of a motor bike and bicycle, they both operate quite differently then what I have set forth. In order for my invention to be more effective, the armoring of the brake lines on a bicycle must be done.

### BRIEF SUMMARY OF INVENTION

This invention is all together one thing. That is, the restraint will not work effectively without the armoring of the brake lines and the securing of all vulnerable weak points within the brake lines that can be severed. This will prevent a thief from just simply cutting through the brake line to bypass the locked restraint on the hand brake. I armored the brake lines because of the restraints vulnerability. Thus making the restraint reliable overall. It is very important to understand they are both one thing together. The reason for this invention is to encourage bicycle riders to take the buses more and with confidence that their bike is it least safe on the front bike rack from thieves.

### BRIEF DESCRIPTION OF DRAWINGS

### DETAILED DESCRIPTION OF THE INVENTION

This invention is a long flexible wire rod that comes with a pad-lock and key and is supported with armored (anti-cut, theft deterrent) brake lines. The wire rod restraint is rubber coated/water resistant and the rubber gives the restraint an added grip overall when it is locked down by pad-lock. The long wire rod is to wrap around both brake lever and handle bar (once brake is engaged) then restrains the bicycle hand brake in place. The pad-lock is then used to lock within itself ALL the wire Central between the brake lever and handle bar thus constricting the restraint further therein. Bike then becomes immobile with brake restrained and locked in place. The restraint is used as a theft deterrent AND the brake lines are armored to support the restraint as well. It is mainly designed to be of use while using the city bus transportation. With the help of the bus driver keeping an eye on your bike it should work out well for people with bikes who would ride the bus more if they felt sure their bike would be ok. It is multi-adjustable in its full flexibility to adequately restrain any hand brake lever on any bicycle in any place within the levers entire full range of pivotal movement. This is especially good due to changes that will happen from normal bicycle brake ware or maintenance done or in the differences in adjustments already in place from one bicycle hand brake to another. It is my goal that for every bicycle that gets the restraint, it will also have the brake lines armored to the full satisfaction of the customer, ensuring the protection of their bicycle. It is important to understand that these two work together. The armored brake lines are pointless (have no purpose) without the restraint and the restraint is not FULL PROOF without armored brake lines. Armor covering will be applied anywhere the brake lines are exposed that could be severed in order to disable the brake restraint. Because there are so many different bicycle designs to do this with, there will be many differences in the fabrication of the armor towards the brake lines from one bicycle to another.

1) A bicycle hand brake restraint with pad-lock and key and fully armored covered brake lines to support restraint, the apparatus comprising:
a. A long flexible wire rod removably coupled at first end,
b. A pad-lock with key,
c. Brake lever non-slip extension,
d. Fabricated suited/custom armor for entire brake line system per each bicycle design,

2) The long flexible wire rod restraint as recited in claim 1 wherein the wire restraint is operatively configured to be removably coupled to the bicycle brake lever or handle bar at first end of restraint.

3) The long flexible wire rod restraint as recited in claim 2, wherein upon engaging the brake, the wire restraint is operatively configured/wrapped around both brake lever and handle bar, thus restraining the brake lever in place hands free.

4) The long flexible wire rod restraint as recited in claim 3, wherein the wire restraint is multi-adjustable, in that upon the engagement of the brake, will be operatively configured to restrain the brake lever anywhere at any place within the brake levers entire full range of pivotal movement.

5) The pad-lock with key as recited in claim 1, wherein upon claims 3 and 4, the pad-lock operatively configures to latch over/around all the wire restraint central between the brake lever and handle bar and locks within itself all of that wire restraint therein thus constricting/tightening the restraint.

6) The pad-lock with key as recited in claim 5, wherein though using the key is the desired way to undo the restraint by unlocking the pad-lock first, the pad-lock does not need to be unlocked by the key to loosen the restraint. The restraint can be operatively loosened without the unlocking of the pad-lock if the key is misplaced.

7) The long flexible wire rod restraint as recited in claims 1 and 2, wherein when not in use, the wire restraint, while still coupled at first end to bicycle, will at second end be operatively wrapped away from hand brake area to another part of the handle bar.

8) The brake lever non-slip extension as recited in claim 1 wherein an extension is added onto the outer end of the brake lever to stop the restraint from being slipped/pulled off.

9) The fabricated suited/custom armor for entire brake line system per each bicycle design as recited in claim 1, wherein fabricated suited armor is applied as “tubing, sleeves and covers” upon the brake lines on every bicycle design and model according to its specific needs that differ from each other, to cover and protect every area of the brake line system that is exposed and vulnerable to being operatively reached and severed.

10) The long flexible wire rod restraint as recited in claim 1, wherein the wire restraint is operatively configured to go on either of both hand brakes.

11) The long flexible wire rod restraint as recited in claim 2, wherein the wire restraint is operatively removed from bicycle at first end of restraint and wrapped anywhere else on bicycle for the storage of restraint.

12) The long flexible wire rod restraint as recited in claim 1, wherein the flexible wire rod is water resistant/rubber coated.

13) The long flexible wire rod restraint as recited in claim 1, wherein the wire rod restraint bares the image of a snake or other creatures or no image at all.

14) The long flexible wire rod restraint as recited in claim 1, wherein the wire restraint is armored with Kevlar or other such flexible anti-cut, anti-theft deterrent material.

15) An adjustable pad-lock.

16) The adjustable pad-lock as recited in claim 15, wherein the adjustable pad-lock operatively locks around and within itself the hand brake lever and handle bar upon the engagement of the hand brake and is operatively configured to restrain the brake lever in place anywhere within the brake levers entire full range of pivotal movement.

17) The bicycle hand brake restraint as recited in claims 1 and 5, wherein the bicycle wheel and tire are prevented from being removed because the brake is engaged and restraint is locked.

18) The brake lever non-slip extension as recited in claims 1 and 8, wherein the non-slip extension is added to the lever near its base, upon that the wire restraint is on brake lever, thus preventing the restraint at first end from being operatively removed from brake lever.
